(19) United States
(12) Patent Application Publication
(10) Pub. No.: US 2002/0049682 A1
(43) Pub. Date: Apr. 25, 2002

(54) Authentication certificate, authentication certificate issuance system, and authentication system

(76) Inventors: Nobuko Yamamoto, Kanagawa (JP); Tsuneya Ohno, Tokyo (JP)

Correspondence Address: ROBIN BLECKER & DALEY, 2ND FLOOR, 330 MADISON AVENUE, NEW YORK, NY, 10017, US

(21) Appl. No.: 09/942,003

(22) Filed: Aug. 29, 2001

(30) Foreign Application Priority Data
Sep. 1, 2000 (JP) 2000-265689
Sep. 1, 2000 (JP) 2000-265690

(51) Int. Cl. G06F 17/60

(52) U.S. Cl. 705/67; 705/76

(57) ABSTRACT

DNA extracted from a blood sample by a DNA extractor is provided to a reactor. The reactor makes a hybridization reaction between a DNA microarray on which a plurality of different types of DNA probes are arranged in a predetermined order, and the extracted DNA. A hybridization pattern is formed on the reacted DNA microarray. An authentication certificate is issued by directly attaching the reacted DNA microarray obtained in this way. Alternatively, an authentication certificate is issued by reading the hybridization pattern by a reader, and recording the read pattern as magnetic/digital information.

### FIELD OF THE INVENTION

The present invention relates to authentication exploiting DNA and, more particularly, to an authentication certificate issuance system, apparatus, and method for issuing an authentication certificate for personal authentication.

The present invention also relates to a user authentication system and method for personal authentication in digital information exchange and electronic commercial transaction, and an authentication apparatus and method.

### BACKGROUND OF THE INVENTION

In personal authentication for driver's licenses, passports, and the like, a highly reliable personal authentication scheme that can identify individuals is required. These licenses are origins of personal authentication, and belong to generic concepts of cash cards and IDs upon entry/exit of facilities.

Currently, photographs are used in personal authentication of driver's licenses and passports. Photographs attached to driver's licenses and passports allow quick comparison and discrimination with lineaments of the driver's license or passport holders. However, when driver's licenses and passports have long valid periods, the lineaments change during such periods, and it often becomes difficult to discriminate. Taking a passport having a valid period of 10 years as an example, the lineament of a given person may change drastically upon growing up from a child to an adult or due to aging so one can only guess “what he or she was used to be”. The lineament changes due to not only an elapse of time but also various factors such as hair styles, the presence/absence of glasses, face-list, diseases, accidents, habits of body (fatness, or the like), and so on, and the impression it gives may often turn around. However, it is too troublesome to revalidate driver's licenses every year. Hence, misuse such as forgery of driver's licenses and passports due to such problems cannot be exterminated.

In recent years, various kinds of information can be accessed via the communication networks: not only electronic commercial transactions such as trade and credit of merchandise and the like, but also on-line diagnosis and personal carte in the medical field, browsing of registered items and credentialing in a public office, financial consultation, speculation, management of deposits and savings, and the like. In this way, objects to be accessed increase, and such use has become prevalent.

For example, since electronic commercial transactions have expanded rapidly since they allow the users to easily get desired objects from world-wide sites without restriction in respect of time. However, a system in which authentication is made by a signature like that for credit cards cannot be used in transactions via communication networks, and a highly reliable user authentication system that can strictly discriminate individuals is required.

A mechanism for correctly authenticating individuals can be applied to a lock system that limits entrance of persons other than qualified persons in, e.g., laboratories, offices, houses, and the like, improvement of security of digital money, and the like. Also, such mechanism is also used upon exchanging information that pertains to privacy such as medical-related consultation, counseling, consultation of asset management, and the like.

In general, a password is most prevalently used in such user authentication. Passwords are simple, but cannot eliminate a person who appropriates a password of another person and poses as that person. For this reason, a scheme for secreting communication contents using an encryption technique is used to assure security in communication processes. However, a ciphertext invented by a person may be decrypted someday.

As alternatives of personal authentication using photographs and user authentication using passwords, a method of authenticating the user using information that represents so-called biological features such as fingerprints, voiceprints, and the like has been examined.

Japanese Patent Laid-Open No. 11-338826 discloses authentication based on handwriting as biological feature data. According to this method, a signature which has high reproducibility is used as handwriting, and not only its shape information but also writing pressure information and writing order information are used as authentication means. This method poses a system in which a signature is registered in advance, a user authentication certificate is acquired at an issuance office, and authentication is made by scanning that user authentication certificate at a place such as an ATM or the like where authentication is required. Furthermore, when authentication must be re-confirmed, the signature of a given person is compared with data of an authentication certificate at an authentication registration office so as to re-confirm the signature together with the writing pressure information and writing order information.

However, the aforementioned method requires a considerably large information size to store the shape of the signature. Since collation requires much time upon authentication, this method is not practical. Since the data size is huge, it becomes harder to save and manage such information in the face of current prevalence of electronic commercial transactions using communication networks.

In the aforementioned method, even if his or her signature has very high reproducibility, a person changes day by day, and if his or her fingers change slightly owing to an injury, disease, or the like, the signature may become different from the previous one. Also, handwritten characters change little by little as a person gets older, and especially, when Chinese characters are used like Japanese people, such changes appear at many positions, thus making discrimination upon authentication difficult. For this reason, an authentication certificate must be updated periodically, and troublesome factors such as an update process, management of information, and the like increase.

To solve this problem, authentication methods using information (vital information) such as fingerprints, voiceprints, ocular fundus blood vessel pattern image, retinal image, and the like, which indicate biological features have been examined. These kinds of information based on biological features are suitable for personal authentication compared to authentication using signatures since they differ from one individual to another, and never change throughout one's life.

Japanese Patent Laid-Open No. 11-338826 above describes a method of acquiring vital information, extracting personal features from that information, converting them into code sequence data, and encrypting the data using a password to make personal authentication, and describes that ocular fundus image, fingerprints, and voiceprints are used as vital information.

However, this method is not practical since such vital information requires a very large information size, and complicated authentication using fingerprints and voiceprints requires a long collation time. Also, since the data size required for each person is large, when data of respective driver's license holders and passport holders are accumulated, the total data size becomes huge, and it becomes hard to save and manage such data.

Japanese Patent Laid-Open No. 2000-94873 also describes a method using a retinal image as vital information, which suffers a large information size as in the aforementioned method.

Digital information (for example, magnetic information, optical information etc.) described on a card may often be erased or destroyed depending on its saving environment. Various kinds of vital information mentioned above can be converted into digital data and can be recorded on cards (driver's licenses and passports). However, when the contents of the recorded information cannot be read due to the influence of environmental factors such as magnetism or electrons and the like, their adverse influences are inestimable.

A user authentication method using vital information indicating so-called biological features such as fingerprints, voiceprints, and the like in user authentication of the aforementioned electronic commercial transactions has also be examined. However, this method is not practical since such information requires a large information size and a long collation time is required upon authentication, as described above. Also, the data size becomes huge, and it becomes harder to save and manage such information in the face of current prevalence of electronic commercial transactions using communication networks.

As described above, various measures against illicit use, forgery, and the like of various cards have been taken to improve their security, but are not technically satisfactory due to too large an information size. Especially, personal authentication of a driver's license, passport, and the like is used as personal authentication means when a problem is posed in another authentication of a cash card or the like, and requires high-precision authentication. Also, high-precision authentication is required for user authentication using a smaller information size.

As is well known, DNA specifies a person with high precision. Japanese Patent Laid-Open Nos. 11-338826 and 2000-94873 above both refer to use of DNA as biological feature data, but do not describe any practical methods.

### SUMMARY OF THE INVENTION

The present invention has been made in consideration of the aforementioned problems, and has as its object to provide an authentication certificate using DNA as biological feature data.

It is another object of the present invention to allow to issue an authentication certificate using DNA as biological feature data, and to issue an authentication certificate that can prevent its illicit use, and can improve security and reliability.

It is still another object of the present invention to reduce an information size for authentication, and to allow an easy collation process.

It is still another object of the present invention to provide an authentication certificate which holds authentication data without deteriorating due to aging factors and environmental factors such as electrons, magnetism, and the like.

It is still another object of the present invention to provide a user authentication system and method, which allow use of DNA in user authentication in digital information exchange and electronic commercial transactions, and can quickly authenticate with high security.

According to one aspect of the present invention, at least one of the foregoing objects is attained by providing a system for issuing an authentication certificate used in personal authentication, comprising reaction means for reacting a DNA array having a known probe layout with DNA of a given person, and issuing means for issuing an authentication certificate where there is a pattern of hybridized probes obtained by the reaction means for the authentication certificate.

According to another aspect of the present invention, there is provided an authentication system for an authentication system for personal authentication, comprising storage means for storing registration information which includes layout information that represents a layout pattern of hybridized probes obtained by reacting a DNA array on which a plurality of probes are arranged with DNA of a given person, acquisition means for acquiring the layout information from an authentication certificate, generation means for generating authentication information on the basis of the layout information acquired by the acquisition means, and authentication means for making authentication by collating the authentication information generated by the generation means with the registration information stored in the storage means.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a diagram showing an example of the arrangement of an authentication certificate issuance system according to the first embodiment of the present invention;

FIG. 2 illustrates a DNA microarray used in the first embodiment;

FIG. 3 illustrates a hybridization pattern of the DNA microarray obtained by a hybridization reaction with DNA of a given user;

FIG. 4 is a flow chart for explaining the processing sequence in the authentication certificate issuance system in the first embodiment;

FIG. 5 is a diagram showing an example of the arrangement of an authentication certificate issuance system according to the second embodiment of the present invention;

FIG. 6 is a block diagram showing the arrangement of a user authentication system of the second embodiment;

FIG. 7 shows the format of registration data of a hybridization pattern according to the second embodiment;

FIG. 8 is a flow chart showing the flow of processes of the authentication procedure of a computer on the user side according to the second embodiment; and

FIG. 9 is a flow chart showing the flow of processes of the authentication procedure of a computer on the order receiver side according to the second embodiment.

### DETAILED DESCRIPTION OF THE PREFERRED EMBODIMENTS

Preferred embodiments of the present invention will now be described in detail in accordance with the accompanying drawings.

[First Embodiment]

<Personal Authentication System>

An issuance system of an identification card that can be applied to a personal authentication system, and its management example will be described first. The embodiment to be described below will exemplify a case wherein the present invention is applied to a driver's license and passport as personal identification cards to improve a security function upon holding and use of card holders.

In this embodiment, a DNA microarray (also called a DNA chip) that has received a lot of attention in recent years is used. The DNA microarray is prepared by densely arranging several hundred to several ten thousand different types of DNA probes on a solid-phase surface of a 1-inch² plate. Upon making a hybridization reaction with sample DNA using this DNA microarray, many genes can be inspected at the same time. These DNA probes are regularly arranged in a matrix pattern, and the address of each probe can be easily extracted as information. Genes to be inspected include single nucleotide polymorphisms of individuals and the like in addition to disease-related genes.

On the other hand, MHC (major histocompatibility complex) genes are those of the human genome where genes of the immune system are concentrated densely, and their nucleotide sequence has been identified recently (Nature Volume 401, p921-923, 1999) and is receiving a lot of attention. This sequence includes genes that pertain to discrimination of compatibility/incompatibility in bone marrow transplantation, organ transplantation, and the like. Nowadays, compatibility/incompatibility in the bone marrow transplantation and organ transplantation is discriminated by inspection using leukocytes. However, since the inspection using leukocytes is time-consuming, and a small information volume is acquired, typing using MHC genes will become the mainstream in the future. MHC (HLA antigens for human) includes three different antigens, i.e., HLA-A, HLA-B, and HLA-C as Class I antigens, and also three different antigens, i.e., HLA-DR, HLA-DQ, and HLA-DP as Class II antigens.

Each person acquires a total of 12 different antigens one each from each parent, which specifies a “pattern”of that person. Currently, a total of about one thousand types of genes of HLA-A, HLA-B, HLA-C, HLA-DR, HLA-DQ, and HLA-DP are identified. New MHC genes are being found one after another, and the number of genes will further increase in the future. Since only 12 different genes are selected from one thousand genes or more, a combination of antigens in the “pattern”of a given person very rarely matches that of another person. In practice, the combination of antigens in the “pattern”rarely matches in the bone marrow transplantation and organ transplantation. This indicates that MHC genes have various patterns and are gene groups suitable for personal authentication. The gene groups never change with age.

Therefore, this embodiment uses a hybridization pattern of each person in the DNA microarray as biological feature data that distinguish individuals, and especially, a DNA microarray pattern that mounts MHC genes. Also, gene groups called SNPs (single nucleotide polymorphisms) can be used as those suitable for personal authentication. This gene group can be added to add another information to the DNA microarray pattern that mounts MHC genes.

As described above, the MHC genes represent the characteristic constitution of that person, and never change depending on the environment or age. The number of genes is an information size that can be stored within a 1-inch² DNA microarray. Therefore, a hybridization pattern of the DNA microarray that mounts MHC genes of a person obtained by reacting the DNA microarray pattern with the genes of that person is used as authentication means. More specifically, a personal authentication certificate such as a driver's license, passport, and the like is generated by directly attaching a DNA microarray having a hybridization pattern obtained by reacting with DNA of each person, or by writing that hybridization pattern as digital (electronic or magnetic and the like) information.

Since the DNA probes on the DNA array are regularly arranged in a matrix pattern, and their order is known, the address of each probe (which can be specified by the row and column addresses) can be easily extracted as information. Hence, the DNA array can identify a person by a smaller information size than complicated image information and signal such as a retinal image, fingerprints, voiceprints, ocular fundus image, and the like.

Furthermore, DNA is very stable against an environment, and is immune to environmental factors such as magnetism, electrons, temperature, light and the like. Hence, the DNA array is suitably appended to an authentication certificate possessed over a long period of time.

In the authentication certificate issuance system according to this embodiment, blood sampling and DNA extraction are made in a driver's license or passport issuance office, and a DNA microarray having a hybridization pattern is generated by a hybridization reaction with a DNA microarray that mounts MHC genes as probes. Furthermore, this hybridization pattern is attached to the driver's license or passport as the DNA microarray or is converted into information such as digital information and is written in each document, and is registered in an authentication office.

The aforementioned personal authentication requires at least about one thousand probes. This value corresponds to the number of MHC genes found so far. However, new genes are found one after another, and the number of genes will further increase. These new genes can be used as probes. The MHC genes never change along with age. This is also a required element suitable for personal authentication. The value which is appropriate as the number of probes required for personal authentication ranges from 1,000 to 10,000. It is important for this authentication system to mount all types of sequences required for personal authentication, and the number of types is assumed to fall within the range from 1,000 to 10,000. Furthermore, the price of each array must be low. When such small number of probes are used, the price of the DNA microarray can be reduced. However, a high-density DNA microarray may be used to satisfy precision requirement.

As described above, SNPs may be additionally used as genes in addition to MHC, and a microarray specified by SNPs alone may be used.

The authentication certificate of this embodiment can be used in the following forms.

When a given person shows a passport upon traveling abroad, his or her photograph and entries are checked in the same manner as the conventional procedure. At this time, if it is found that the passport is a stolen one, emigration/immigration is denied, and if any dubiety is found, a blood sample is taken at that place and reacted with the DNA array to be collated with the DNA pattern described on the passport.

The personal authentication is preferably done for all persons every time they go abroad, but is not practical now since it requires a long checking time. However, since secure discrimination means can be assured when any unconformity with entries is found, a high barrier against forgery is set to prevent crimes. If a less-invasive blood sampling method is established and the checking time is shorter in the future, personal authentication may be made by taking a blood sample every travel abroad and comparing it with information on the passport.

Also, personal authentication of a driver's license is made by the same method. That is, a DNA array pattern is obtained by sampling blood in, e.g., a police office, and that information is described on a driver's license. When a given person is in an accident, his or her blood is sampled to obtain a hybridization pattern on the DNA array, thus authenticating if that person is the license holder himself or herself. When MHC genes are used in such authentication, medical information required in injury treatment after the accident can be provided. For example, the MHC genes are effectively used to select a candidate in, e.g., organ transplantation, and are effective in terms of emergency lifesaving. The driver's license can be easily updated by checking if a pattern obtained by blood sampling matches that described on the license.

If it is suspected that the driver's license or passport is a stolen or lost one, DNA is re-inspected based on blood, and it can be confirmed if the DNA microarray used matches the person of interest. Upon updating the driver's license or passport, processes for sampling blood and checking if the sampled pattern matches the registered DNA array pattern are added.

The driver's license and passport preferably use a common DNA microarray. It is important that the DNA array from which the registered pattern is obtained be of the same type as that upon checking for collation in police and immigration offices universally.

If blood can be easily sampled without the intervention of any organization such as a hospital or the like, and a system that integrates DNA extraction using the blood sample and hybridization reaction after that is available, each passport issuance office, police office, or the like can easily generate a DNA microarray having a DNA hybridization pattern unique to each person.

In case of the driver's license and passport, the DNA array is preferably attached thereto without being converted into digital information. This is to avoid any troubles upon emigration/immigration due to confirmation errors, since digital information is readily erased or destroyed when it is exposed to an information destruction means or environment.

<Authentication Certificate Issuance System for Personal Authentication>

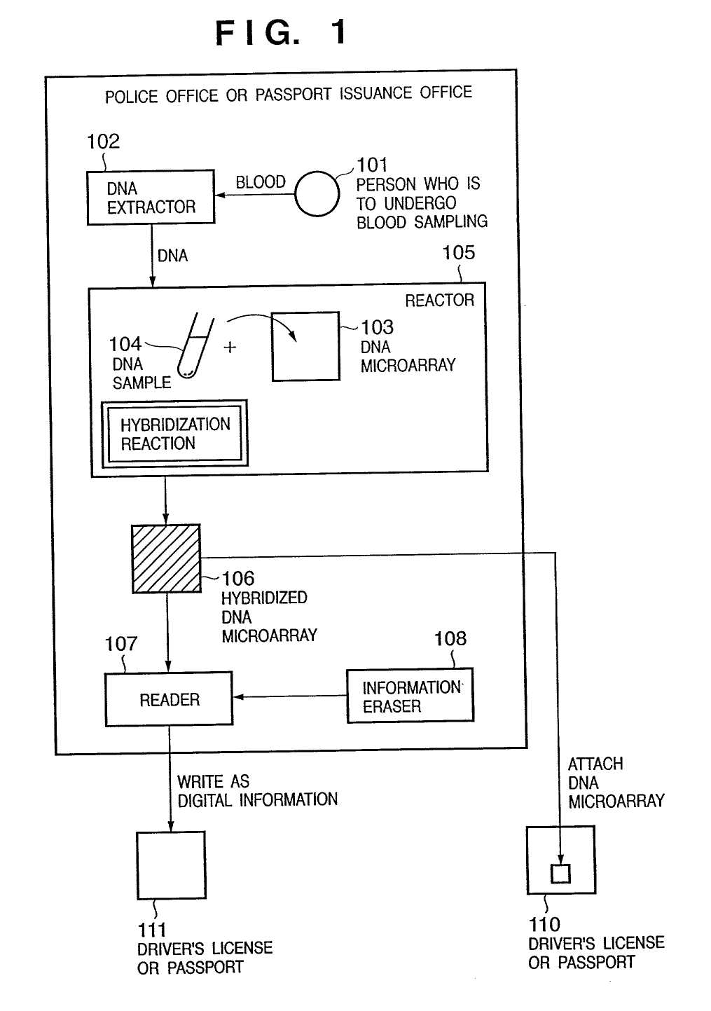

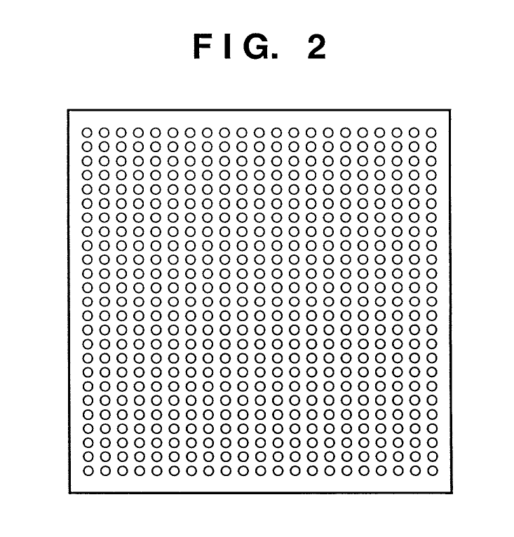

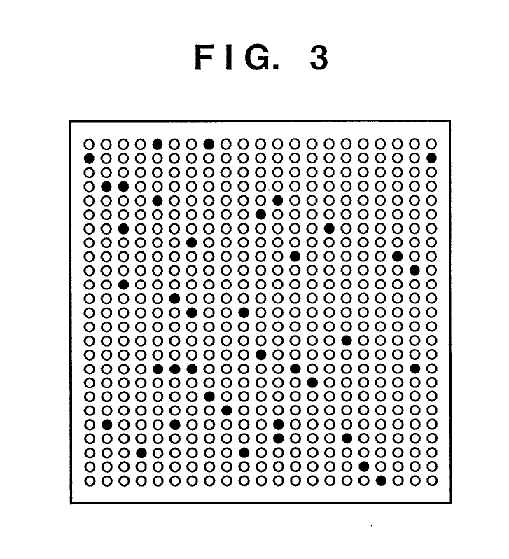

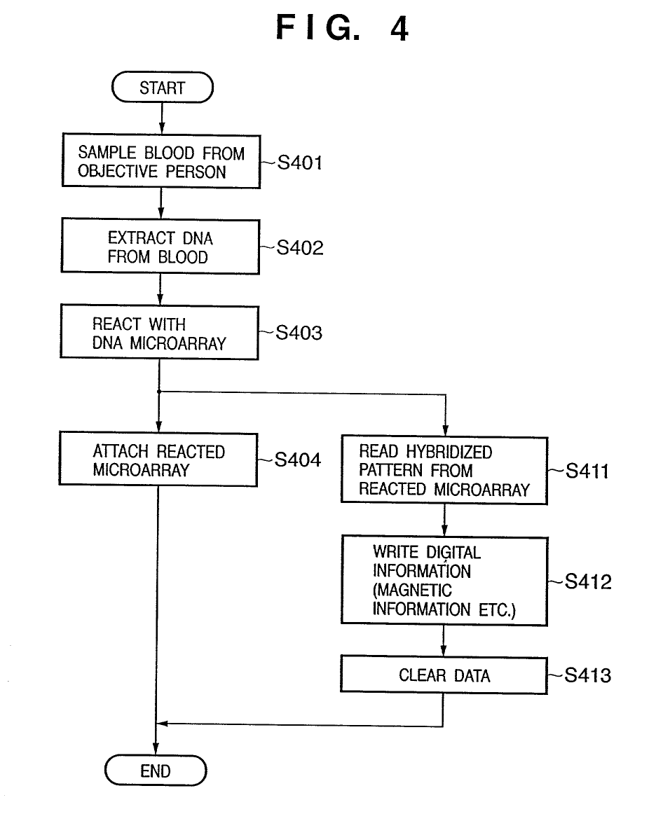

FIG. 1 shows an example of the arrangement of an authentication certificate issuance system of this embodiment. FIG. 2 illustrates a DNA microarray used in this embodiment. FIG. 3 shows a hybridization pattern obtained via a hybridization reaction between DNA extracted from the blood of a given user and the DNA microarray. Furthermore, FIG. 4 is a flow chart for explaining the processing sequence in the authentication certificate issuance system of this embodiment. Note that these figures show an embodiment of the present invention, which is not limited by them.

A DNA array used as a personal authentication means for a driver's license or passport is generated using the arrangement shown in FIG. 1 in the sequence shown in FIG. 4. However, the generation method is not limited to this specific method.

A blood sample taken from a given person who is to undergo blood sampling (a person to be authenticated) 101 by, e.g., a doctor in a police office or passport issuance office is provided to a DNA extractor 102, which extracts DNA 104 (steps S401 and S402). The DNA 104 extracted by the DNA extractor 102 is reacted with a predetermined MHC gene detection DNA microarray 103 (step S403). Note that the MHC gene DNA microarray 103 is selected for a driver's license or passport in advance from many types of DNA microarrays having different numbers of DNA probes mounted, different layouts of probes, different types of SNPs added, and the like, and is commonly used for all people.

The DNA microarray 103 has a pattern shown in, e.g., FIG. 2. In FIG. 2, DNA probes having different sequences are bound to regions indicated by white dots. The extracted DNA 104 and DNA array 103 are set in a reactor 105, and undergo a hybridization reaction.

The DNA microarray after reaction is as shown in, e.g., FIG. 3. In FIG. 3, each region indicated by a black dot is a probe that forms a hybrid with the user's DNA, and a pattern formed by these hybrids (black dots) is a hybridization pattern, which is used in personal authentication in this embodiment.

The surface of a reacted DNA microarray 106 is protected by a protection agent, and is directly attached to a driver's license or passport (authentication certificate) 110, thus providing an authentication certificate used as personal authentication means (step S404). Alternatively, the hybridization pattern on the reacted DNA microarray 106 is read by a reader 107 (step S411) and is converted into digital information, and the converted information is stored on an authentication certificate 111 such as a driver's license, passport, or the like by, e.g., magnetic recording and can be used in authentication (S412). For example, upon converting the hybridization pattern into digital information, the positions of hybrid (38 black dots in this embodiment) in the hybridization pattern shown in FIG. 3 are read, and data indicating these positions are used as digital information.

Upon completion of write of the digital information, digital information of the hybridization pattern in the reader is erased by an information eraser 108 (step S413). This erasure may be made manually by the person to be authenticated or automatically.

Note that issuance of an authentication certificate requires the intervention of a doctor if blood sampling must be done. Preferably, all processes are automated using an automatic apparatus. Furthermore, if detection using DNA from sputum, mucosa, or the like that can be easily acquired is allowed, the user can generate an authentication certificate more easily.

[Second Embodiment]

In the first embodiment, the hybridization pattern formed on the DNA microarray is applied to personal authentication of a passport, driver's license, and the like. In the second embodiment, an authentication certificate using a hybridization pattern formed on a DNA microarray, which is suitably applied to a user authentication system used in, e.g., transactions via the Internet, a system for issuing the authentication certificate, and an authentication system using the same will be explained.

<Authentication Certificate in User Authentication System>

Unlike the personal authentication system described in the first embodiment, a DNA microarray used by the user need not be common to all people. Using identical probes, and DNA microarrays having different arrangements of probes, a variety of authentication patterns can be added. That is, patterns generated by respective hybridization reactions are important, and the diversity of patterns leads to high security. Note that the layouts of DNA microarrays are registered in advance, and when the user obtains his or her MHC pattern again using the identical array, the same pattern as the old pattern must be obtained. This can prove the true holder of a DNA microarray if it is stolen. For example, when the pattern number that specifies the probe layout of the DNA microarray and the hybridization pattern of a given person are used in authentication in correspondence with each other, authentication with higher precision can be realized.

As the DNA microarray required for user authentication, an array having a relatively small number of probes is preferably used initially. On the other hand, if a DNA array written with a gene pattern of a given user is passed to another person since it is stolen or lost, a new DNA microarray must be generated using another type of DNA microarray and user's DNA. As the new DNA microarray, an array having a larger number of probes or a different probe layout can be used. When the number of probes is increased, SNPs can be used as genes other than MHC. In this case, the optimal number of probes ranges from 10,000 to 50,000, and the price of the DNA microarray rises since the number of probes increases.

When DNA information stolen by or passed to a third party due to loss is ill-used, the true holder of the DNA microarray used can be confirmed based on user's blood.

In the second embodiment, upon generating a DNA microarray reacted with the user's DNA, the user himself or herself purchases a DNA microarray having a desired layout, and reacts it with DNA extracted from the blood sample, which is ideal to obtain by himself or herself using an appropriate device. This is to avoid information leakage, and to assure high security. Blood sampling may be entrusted to an expert and DNA may be extracted by an expert in, e.g., a hospital, or by the user himself or herself if a DNA extractor or the like is available. The user preferably executes required processes as much as possible in terms of security.

If blood can be easily sampled without the intervention of any organization such as a hospital or the like, and a system that integrates DNA extraction using the blood sample and hybridization reaction after that is available, each person can generate a DNA microarray with a unique DNA hybridization pattern without requiring any special facilities such as a hospital, authentication certificate issuance office, and the like.

When a DNA microarray reacted with the user's DNA is analyzed using a reader, and the analysis result is described on a card as digital information, such processes are preferably done by the user. Furthermore, that information is preferably erased by the user himself or herself after the card is generated. All such operations lead to high security.

<Authentication Certificate Issuance System for User Authentication>

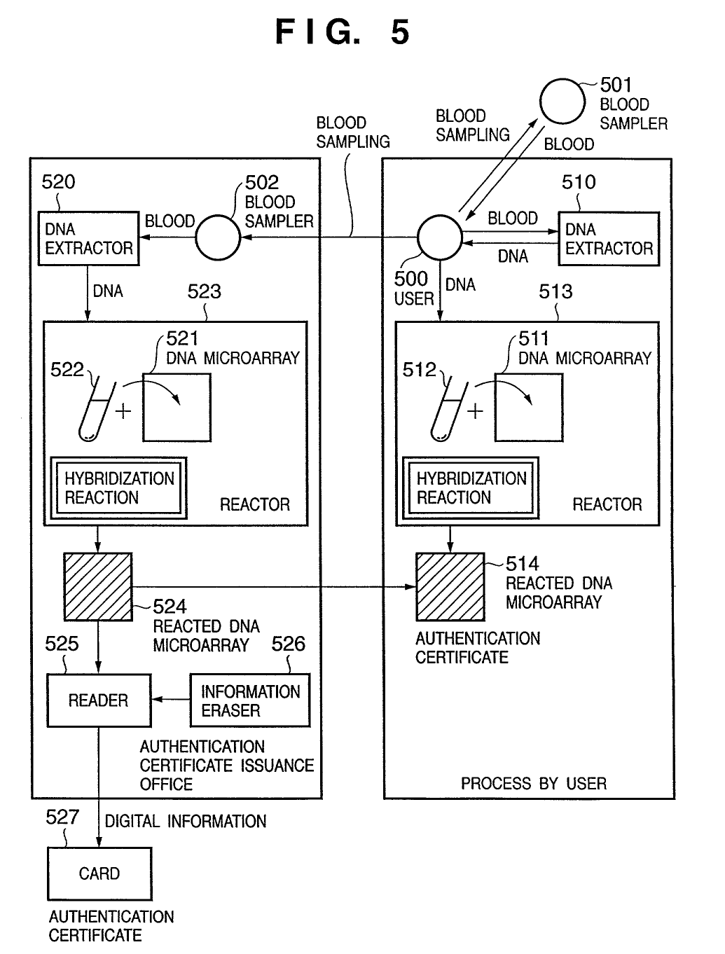

A user authentication certificate is generated, as shown in, e.g., FIG. 5. Note that the sequence will be explained while quoting the flow chart shown in FIG. 4. The generation method is not limited to this specific method.

In the authentication certificate issuance system of this embodiment, each user purchases a DNA microarray of a desired layout which mounts MHC genes as probes, generates a DNA microarray having a hybridization pattern by making blood sampling, DNA extraction, and hybridization reaction using a hospital, predetermined organization, or predetermined system, and uses that microarray in authentication. These processes will be described in detail below.

A user 500 applies to a blood sampler 501 such as a doctor or the like for blood sampling in an organization such as a hospital or the like (step S401). The sampled blood is input to a DNA extractor 510 to extract DNA 512 (step S402). The user selects and purchases a desired DNA microarray 511 used to generate an authentication certificate from commercially available DNA microarrays (e.g., MHC gene detection DNA microarrays). The MHC gene DNA microarray is selected from many types of DNA microarrays having different numbers of DNA probes mounted, different layouts of probes, different types of SNPs added, and the like. Note that the DNA microarray has a pattern described above with reference to FIG. 2.

The user sets a purchased DNA microarray 511 and his or her own extracted DNA solution 512 in a reactor 513 to react them (step S403). A DNA microarray 514 after reaction has a hybridization pattern, as shown in, e.g., FIG. 3. After the surface of the reacted DNA microarray 514 is protected by a protection agent, the ill microarray can be used as an authentication certificate directly or after it is attached to a predetermined authentication certificate having, e.g., a card shape (step S404).

The sequence for generating the reacted DNA microarray by the user himself or herself has been explained. As another embodiment of authentication certificate issuance, the processes from blood sampling to hybridization reaction may be done in an authentication certificate issuance office. That is, in the authentication certificate issuance office, blood sampled from the user 500 by an expert (blood sampler) 502 is provided to a DNA extractor 520 to obtain a DNA solution 522. The user 500 purchases a desired DNA microarray 521, and provides it to a reactor 523 together with the DNA solution 522, thus obtaining a reacted DNA microarray 524 (steps S401 to S403). After the surface of the reacted DNA microarray 524 is protected by a protection agent, the microarray can be used as an authentication certificate directly or after it is attached to a predetermined authentication certificate (step S404). When the reacted DNA microarray is directly used as an authentication certificate, an authentication certificate on the substrate of which a DNA microarray is integrally formed may be used.

In addition to the method of using the reacted DNA microarray 524 itself as an authentication certificate or attaching it to an authentication certificate, data that represents a hybridization pattern may be written in a card as digital information to generate a card-shaped authentication certificate.

That is, the hybridization pattern on the reacted DNA microarray 524 is read by a reader 525 (step S411) and is converted into digital information, and the converted information is stored in a card-shaped authentication certificate 527 which is used in authentication (step S412).

This method is easy for, e.g., an aged person who is not accustomed to operate a device since the user does not make any reaction operation by himself or herself, but information may leak and pose a security concern. To solve this problem, an information eraser 526 for erasing the data on the reader 525 used in generation of the authentication certificate automatically or manually by the user is provided, and the data that pertains to the hybridization pattern is erased (step S413).

Note that issuance of an authentication certificate requires the intervention of a doctor if blood sampling must be done. Preferably, all processes are done by the user himself or herself using, e.g., an automatic apparatus. Furthermore, if detection using DNA from sputum, mucosa, or the like that can be easily acquired is allowed, the user can generate an authentication certificate more easily.

Note that the DNA extractor and reactor shown in FIGS. 1 and 5 can constitute an authentication certificate issuance apparatus for automatically issuing an authentication certificate.

<Use of User Authentication System>

A case will be explained below wherein user authentication using the aforementioned DNA hybridization pattern is applied to digital information exchange or electronic commercial transactions via the Internet.

In the first transaction via the Internet, the user registers an image pattern of a DNA microarray having a pattern unique to himself or herself generated by the aforementioned method in an apparatus of a transaction partner. In this embodiment, the hybridization pattern on the DNA microarray (the hybridization pattern on the DNA microarray of MHC genes of the user himself or herself) is read by a scanner, and the read data is sent to a partner's computer, which registers the received data.

From the next transaction, the user sets the same DNA microarray used in the first transaction on the scanner to read the hybridization pattern, and sends the read data to the partner. The partner's computer collates the received hybridization pattern with the registered hybridization pattern to authenticate the user. Note that the scanner connected to each user's computer is not particularly limited as long as it can detect a 1-inch² DNA microarray.

When personal DNA microarray pattern data is converted into digital information and is written as digital information such as magnetic information, optical information etc. on a card or the like (to be referred to as a user authentication certificate hereinafter), and that card is registered as an authentication certificate, authentication on each user's computer can be made using that authentication certificate. In such case, no scanner is required as an authentication equipment, and a device (e.g., a card reader) that reads information (information representing the hybridization pattern) written in the user authentication certificate by some method is connected instead. When the user authentication certificate is used, the operation is the same as that upon directly using the DNA microarray. That is, the user sends data which represents the hybridization pattern to the partner's computer via the Internet in the first transaction, and registers the data. In the second and subsequent transactions, digital information exchange or electronic commercial transaction is done by collating the registered data and that sent by the user.

Internet transactions that use the user authentication system of this embodiment will be described in more detail below with reference to the accompanying drawings.

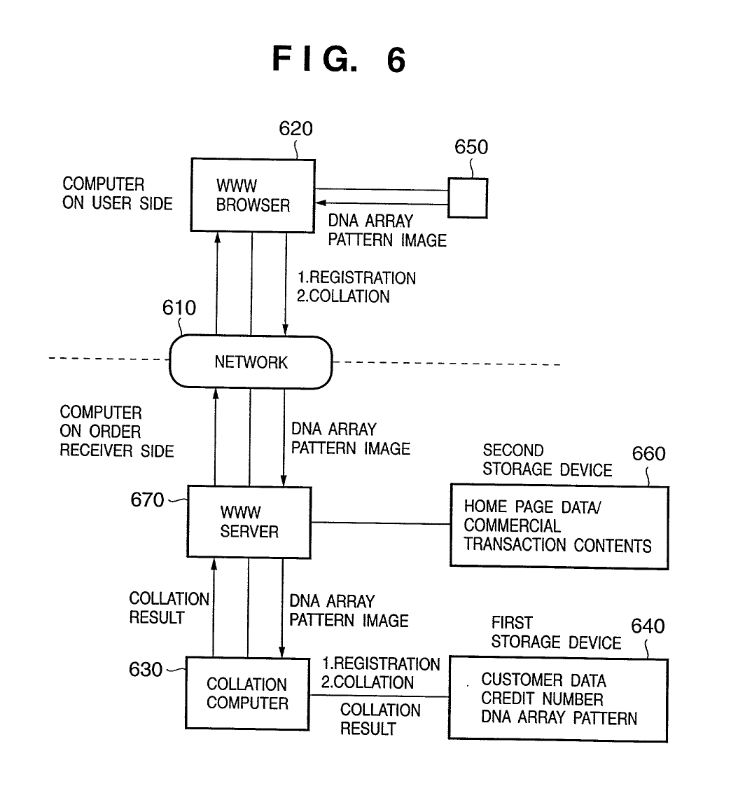

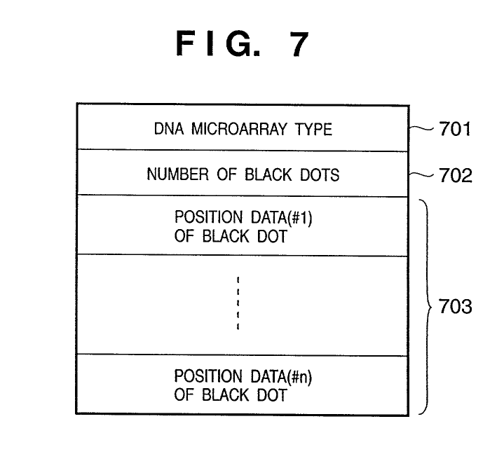

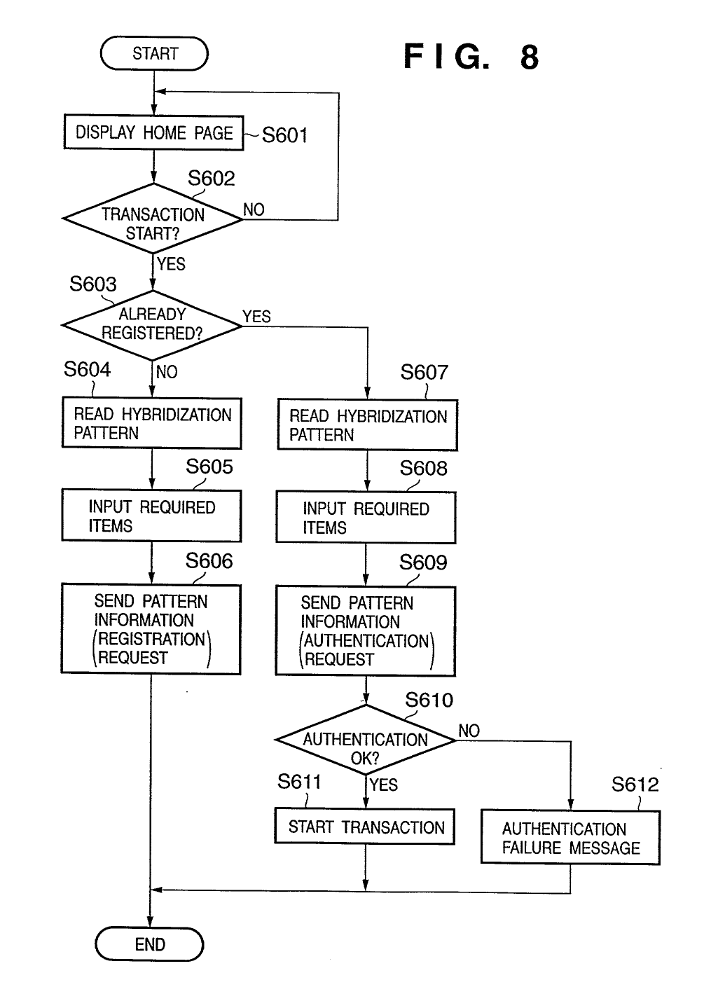

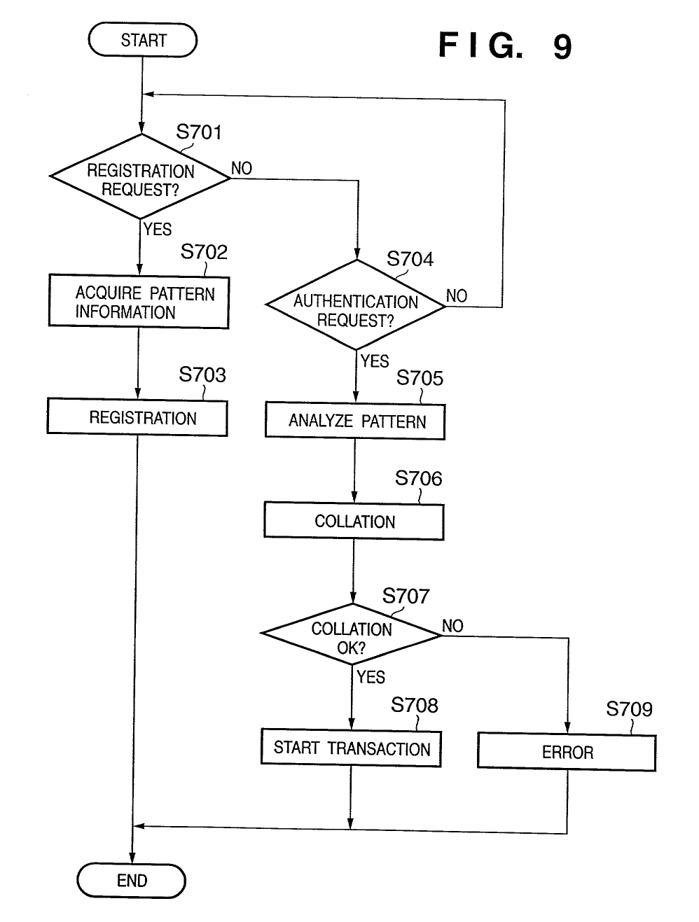

FIG. 6 is a block diagram showing the arrangement of the user authentication system of this embodiment. FIG. 7 shows the format of registration data of the hybridization pattern according to this embodiment. FIG. 8 is a flow chart showing the flow of processes of the authentication procedure by a computer on the user side according to this embodiment. FIG. 9 is a flow chart showing the flow of processes of the authentication procedure by a computer on the order receiver side according to this embodiment.

Note that these figures merely show an embodiment of the present invention, and the present invention is not limited to them.

A system on the orderer side comprises a WWW (World Wide Web) browser apparatus 620, and a scanner 650 used to detect a DNA microarray. As the WWW browser apparatus 620, a versatile system obtained by installing WWW browser software in a commercially available versatile personal computer can be used. This versatile system serves as a computer on the orderer side. Therefore, in this embodiment, the orderer need not prepare for any special dedicated hardware and software, and need only prepare for a general environment that allows connection to the Internet to browse a home page via the WWW browser.

On the other hand, a system on the order receiver side constitutes an order reception system via a network 610. A first storage device 640 stores credit numbers and registered data of hybridization patterns of DNA microarrays of customers as customer data possessed by the order receiver. Note that the first storage device 640 is a database for a collation computer apparatus 630 required for user authentication using a DNA microarray, and comprises a hard disk device, MO drive device, or the like.

As the storage format of each hybridization pattern, a format shown in FIG. 7 may be used as an example. In FIG. 7, a field 701 registers a DNA microarray type, i.e., a type number corresponding to the layout pattern of a DNA microarray that forms the hybridization pattern of interest. This type number can uniquely specify the probe layout of the DNA microarray used. A field 702 registers the number of hybridized probes (i.e., “the number of black dots” shown in FIG. 3) in the hybridization pattern of interest. Fields 703 register coordinate data indicating the positions of the hybridized probes (i.e., “the positions of hybrids (black dots)” shown in FIG. 3) in the pattern of interest. Since the coordinate data are registered, the total information size is very small.

Referring back to FIG. 6, a WWW server apparatus 670 has a function of providing home page data stored in a second storage device 660 to the WWW browser apparatus 620 via the network 610. More specifically, a system prepared by installing WWW server software in a general server computer can be used as the WWW server apparatus 670. The second storage device 660 is an external storage device of this server computer, stores information that pertains to digital information exchange or electronic commercial transactions, and comprises a hard disk device, MO drive device, or the like. Note that the WWW server apparatus 670 and collation computer apparatus 630 may be constituted by a single computer, and they will be referred to as a computer on the order receiver side together in this specification.

In the above arrangement, when the user establishes connection to the WWW server apparatus 670 of the computer of the order receiver side from the WWW browser apparatus 620 via the network 610, the home page for an order procedure is displayed (step S601). When the user is interested in digital information exchange contents on that home page and wants to start a transaction, he or she instructs the start of the transaction on the home page (step S602). If the current transaction is the first one, the user makes user registration on the order receiver side (steps S603 to S606).

In user registration, the user reads as a digital image his or her own MHC pattern (hybridization pattern) on the DNA microarray generated in advance using the scanner 650 connected to the computer (WWW browser apparatus 620) on the user side (step S604), and inputs required items such as the user name, DNA microarray type, and the like on a registration form of the home page (step S605). The user generates pattern information (collation information) on the basis of the pattern data read in step S604 and the data input in step S605, and submits that information to the computer 630 on the order receiver side via the network 610 (step S606), thus registering the information. The registration operation is required only in the first transaction unless a DNA microarray is stolen or lost.

Note that the pattern information submitted to the WWW server apparatus 670 together with the registration request in step S606 contains the hybridization pattern read by the scanner 650, DNA array type, user name, and the like. The hybridization pattern may be submitted after being converted into information that indicates the number and positions of hybridized dots shown as black dots in FIG. 4, or the read image may be directly submitted. When the image is directly submitted, the collation computer 630 must convert it into data indicating the number and hybrids positions (black dots shown in FIG. 4). The DNA array type and user name can be input from the browser window (step S605).

On the other hand, in the computer on the order receiver side that received the pattern information together with the registration request, the collation computer 630 generates data in the format shown in FIG. 7 by analyzing a received hybrid pattern image, and registers it in the first storage device 640 in correspondence with the user name and the like (steps S701 to S703). When the information shown in FIG. 4 is generated by the computer on the orderer side, it can be directly stored in the first storage device 640.

When the user wants to actually make a transaction after the aforementioned registration process, he or she repeats the operation. That is, the user establishes connection to the WWW server apparatus 670 of the computer on the order receiver side via the network, generates pattern information on the basis of data obtained by reading the DNA array using the scanner 650, and submits that information to the order receiver side (steps S607 to S609). In this case as well, the pattern information contains the user name and DNA microarray type. In step S609, however, the pattern information (collation information) is submitted together with an authentication request.

The pattern information to be submitted contains an image obtained by reading the hybridization pattern using the scanner 650 or data shown in FIG. 7 obtained by analyzing that image by the computer on the user side if the user has an authentication certificate attached with the DNA microarray. On the other hand, if the user has an authentication certificate on which the hybridization pattern is magnetically recorded, the pattern information contains data obtained by reading that data. Note that the pattern information to be submitted contains the DNA microarray type and user name, which are input by a keyboard or the like via the browser as needed.

On the order receiver side, the collation computer 630 analyzes the received pattern information, and collates the received pattern information and the registered pattern stored in the first storage device 640 of the computer 630. Upon collation, the received pattern information is analyzed to extract the user name, DNA microarray type, pattern data (the number and positions of reaction probes), and the like (step S705). The registered pattern information is searched using, e.g., the user name, and the found pattern information is collated with the received pattern data and DNA microarray type (steps S704 to S706).

If it is determined as a result of collation that the two patterns match, a transaction starts (steps S707 and S708). That is, information indicating the authentication result is OK and information (commercial transaction contents) stored in the second storage device 660 are sent from the WWW server apparatus 670 to the computer on the user side via the network 610. On the other hand, if the two patterns do not match, information indicating that the authentication result is NG is sent to the user in step S709.

If the authentication result is OK, the computer on the user side displays commercial transaction contents sent from the computer on the order receiver side using the browser, and starts a transaction (step S611). If authentication has failed, a message indicating this is presented to the user (step S612).

Note that payment for the electronic commercial transaction or provided information is made after personal authentication by collation using the pattern on the DNA microarray read by the scanner. In this case, a “password” or the like as the conventional method may be used in addition to presentation of a credit number and collation using the MHC pattern image data on the DNA microarray.

A mechanism for correctly authenticating individuals can be applied to a lock system that limits entrance of persons other than qualified persons in, e.g., laboratories, offices, houses, and the like, improvement of security of digital money, and the like. Also, information that requires privacy such as medical-related consultation, counseling, consultation of asset management, and the like is often exchanged.

As described above, according to the second embodiment, since a DNA array is used in user authentication in digital information exchange and electronic commercial transactions, the information size required for specifying a person can be reduced, and authentication can be securely and quickly made.

Note that the second embodiment has exemplified authentication using a plurality of apparatuses via the Internet. Also, the present invention can be applied to an authentication apparatus which makes authentication in a single apparatus. In this case, the scanner 650 is connected to the aforementioned collation computer 630, which directly analyzes a pattern image on a DNA microarray read by the scanner 650 upon authentication.

When information indicating the hybridization pattern is stored in an authentication certificate as digital or magnetic information, information indicating the DNA microarray type is stored together, and the need for inputting the DNA microarray type in steps S605 and S608 may then be obviated.

Note that the objects of the present invention are also achieved by supplying a storage medium, which records a program code of a software program that can implement the functions of the above-mentioned embodiments to the system or apparatus, and reading out and executing the program code stored in the storage medium by a computer (or a CPU or MPU) of the system or apparatus.

In this case, the program code itself read out from the storage medium implements the functions of the above-mentioned embodiments, and the storage medium which stores the program code constitutes the present invention.

As the storage medium for supplying the program code, for example, a floppy disk, hard disk, optical disk, magneto-optical disk, CD-ROM, CD-R, magnetic tape, nonvolatile memory card, ROM, and the like may be used.

The functions of the above-mentioned embodiments may be implemented not only by executing the readout program code by the computer but also by some or all of actual processing operations executed by an OS (operating system) running on the computer on the basis of an instruction of the program code.

Furthermore, the functions of the above-mentioned embodiments may be implemented by some or all of actual processing operations executed by a CPU or the like arranged in a function extension board or a function extension unit, which is inserted in or connected to the computer, after the program code read out from the storage medium is written in a memory of the extension board or unit.

As described above, according to the present invention, an authentication certificate which uses DNA as biological feature data can be issued and can be prevented from being illicitly used, thus improving its security and reliability.

Also, according to the present invention, the information size required for authentication can be reduced, and a collation process can be easily done.

Furthermore, according to the present invention, an authentication certificate which can hold data for authentication to be free from deterioration due to aging factors and environmental factors such as electrons, magnetism, and the like can be provided.

Moreover, according to the present invention, DNA can be used in user authentication in digital information exchange and electronic commercial transactions, and a user authentication system that can achieve secure and quick authentication can be provided.

As many apparently widely different embodiments of the present invention can be made without departing from the spirit and scope thereof, it is to be understood that the invention is not limited to the specific embodiments thereof except as defined in the appended claims.

What is claimed is:

1. A system for issuing an authentication certificate used in personal authentication, comprising:
reaction means for reacting a DNA array having a known probe layout with DNA of a given person; and
issuing means for issuing an authentication certificate where there is a pattern of hybridized probes obtained by said reaction means for the authentication certificate.

2. The system according to claim 1, wherein said issuing means issues the authentication certificate by attaching the reacted DNA array obtained by said reaction means to the base.

3. The system according to claim 1, wherein said issuing means issues the authentication certificate on which layout information that expresses positions of hybridized probes using numerical values is recorded.

4. The system according to claim 3, wherein the layout information is magnetically recorded.

5. The system according to claim 3, wherein the layout information is recorded in the form of digital information.

6. The system according to claim 3, wherein the DNA array is formed by arranging a plurality of probes in row and column directions, and
the layout information expresses the positions of the hybridized probes on the DNA array using row and column addresses.

7. The system according to claim 1, wherein DNA probes of the DNA array comprise gene probes associated with major histocompatibility complex antigens.

8. The system according to claim 1, wherein DNA probes of the DNA array comprise gene probes associated with major histocompatibility complex antigens and single nucleotide polymorphisms.

9. The system according to claim 1, further comprising extraction means for extracting DNA from a blood sample, and providing the DNA to said reaction means.

10. The system according to claim 1, wherein a substrate on which the base and the DNA array are integrally formed is used.

11. A method for issuing an authentication certificate used in personal authentication, comprising:
the reaction step of reacting a DNA array having a known probe layout with DNA of a given person; and
the issuing step of issuing an authentication certificate where there is a pattern of hybridized probes obtained in the reaction step for the authentication certificate.

12. The method according to claim 11, wherein the issuing means includes the step of issuing the authentication certificate by attaching the reacted DNA array obtained in the reaction step to the base.

13. The method according to claim 11, wherein the issuing step includes the step of issuing the authentication certificate on which layout information that expresses positions of hybridized probes using numerical values is recorded.

14. The method according to claim 13, wherein the layout information is magnetically recorded.

15. The method according to claim 13, wherein the layout information is recorded in the form of digital information.

16. The method according to claim 13, wherein the DNA array is formed by arranging a plurality of probes in row and column directions, and
the layout information expresses the positions of the hybridized probes on the DNA array using row and column addresses.

17. The method according to claim 11, wherein DNA probes of the DNA array comprise gene probes associated with major histocompatibility complex antigens.

18. The method according to claim 11, wherein DNA probes of the DNA array comprise gene probes associated with major histocompatibility complex antigens and single nucleotide polymorphisms.

19. The method according to claim 11, further comprising the extraction step of extracting DNA from a blood sample, and providing the DNA to the reaction step.

20. The method according to claim 11, wherein a substrate on which the base and the DNA array are integrally formed is used.

21. An apparatus for issuing an authentication certificate used in personal authentication, comprising:
reaction means for reacting a DNA array having a known probe layout with DNA of a given person; and
issuing means for issuing an authentication certificate where there is a pattern of hybridized probes obtained by said reaction means to a base for the authentication certificate.

22. The apparatus according to claim 21, wherein said issuing means issues the authentication certificate by attaching the reacted DNA array obtained by said reaction means to the base.

23. The apparatus according to claim 21, wherein said issuing means issues the authentication certificate on which layout information that expresses positions of hybridized probes using numerical values is recorded.

24. The apparatus according to claim 21, further comprising extraction means for extracting DNA from a blood sample, and providing the DNA to said reaction means.

25. An authentication system for personal authentication, comprising:
storage means for storing registration information which includes layout information that represents a layout pattern of hybridized probes obtained by reacting a DNA array on which a plurality of probes are arranged with DNA of a given person;
acquisition means for acquiring the layout information from an authentication certificate;
generation means for generating authentication information on the basis of the layout information acquired by said acquisition means; and
authentication means for making authentication by collating the authentication information generated by said generation means with the registration information stored in said storage means.

26. The system according to claim 25, wherein the registration information and authentication information contain the layout information and type information used to specify a probe layout on the DNA array.

27. The system according to claim 25, wherein the layout information includes data that represent positions of the hybridized probes on the DNA array by coordinate values.

28. The system according to claim 25, wherein the authentication certificate includes a reacted DNA array on which a reaction pattern is formed upon reaction with a DNA of a given person, and
said acquisition means comprises a scanner for reading the hybridized pattern of the reacted DNA array as an image, and conversion means for detecting probes after reaction from the read image, and converting the detected probes into the layout information.

29. The system according to claim 25, wherein the authentication certificate records the layout information as digital information, and
said acquisition means acquires the layout information by reading the digital information.

30. The system according to claim 25, wherein the authentication certificate records the layout information as magnetic information, and
said acquisition means acquires the layout information by reading the magnetic information.

31. The system according to claim 25, further comprising registration means for storing the authentication information generated by said generation means in said storage means as the registration information.

32. The system according to claim 25, wherein the DNA array comprises gene probes associated with major histocompatibility complex antigens.

33. The system according to claim 25, wherein the DNA array comprises gene probes associated with major histocompatibility complex antigens and single nucleotide polymorphisms.

34. The system according to claim 25, wherein the DNA array is formed by arranging a plurality of probes in row and column directions, and
the layout information expresses the positions of the hybridized probes on the DNA array using row and column addresses.

35. The system according to claim 25, wherein the authentication information and registration information contain person specifying information for specifying a given person, and
said authentication means makes authentication by searching said storage means for registration information which contains the same person specifying information as the person specifying information contained in the authentication information generated by said generation means, and collating the layout information of the generated authentication information and the registration information found by search.

36. The system according to claim 25, wherein an apparatus having said acquisition means and said generation means, and an apparatus having said storage means and said authentication means are connected via the Internet, and the authentication information is sent via the Internet.

37. An apparatus for sending an authentication request to an external apparatus, comprising:
acquisition means for acquiring layout information that represents a layout pattern of reaction probes obtained by reacting a DNA array on which a plurality of probes are arranged by reading an authentication certificate;
generation means for generating authentication information on the basis of the layout information acquired by said acquisition means;
registration request means for sending the authentication information to the external apparatus to request user registration; and
authentication request means for sending the authentication information to the external apparatus to request authentication.

38. An apparatus for making user authentication in response to an authentication request from an external apparatus, comprising:
reception means for receiving authentication information which includes layout information that represents a layout pattern of hybridized probes obtained by reacting a DNA array on which a plurality of probes are arranged with DNA of a given person, and instruction information indicating a registration request or authentication request;
registration means for, when the instruction information indicates the registration request, making user registration on the basis of the authentication information received by said reception means; and
authentication means for, when the instruction information indicates the authentication request, making user authentication on the basis of the authentication information received by said reception means, and registration contents registered by said registration means.

39. An authentication method for personal authentication using storage means for storing registration information which includes layout information that represents a layout pattern of hybridized probes obtained by reacting a DNA array on which a plurality of probes are arranged with DNA of a given person, comprising:
the acquisition step of acquiring the layout information from an authentication certificate;
the generation step of generating authentication information on the basis of the layout information acquired in the acquisition step; and
the authentication step of making authentication by collating the authentication information generated in the generation step with the registration information stored in said storage means.

40. The method according to claim 39, wherein the registration information and authentication information contain the layout information and type information used to specify a probe layout on the DNA array.

41. The method according to claim 39, wherein the layout information includes data that represent positions of the hybridized probes on the DNA array by coordinate values.

42. The method according to claim 39, wherein the authentication certificate includes a reacted DNA array on which a reaction pattern is formed upon reaction with a DNA of a given person, and
the acquisition step comprises the conversion step of detecting probes after reaction from an image read by a scanner for reading the reaction pattern of the reacted DNA array as an image, and converting the detected probes into the layout information.

43. The method according to claim 39, wherein the authentication certificate records the layout information as digital information, and
the acquisition step includes the step of acquiring the layout information by reading the digital information.

44. The method according to claim 39, wherein the authentication certificate records the layout information as magnetic information, and
the acquisition step includes the step of acquiring the layout information by reading the magnetic information.

45. The method according to claim 39, further comprising the registration step of storing the authentication information generated in the generation step in said storage means as the registration information.

46. The method according to claim 39, wherein the DNA array comprises gene probes associated with major histocompatibility complex antigens.

47. The method according to claim 39, wherein the DNA array comprises gene probes associated with major histocompatibility complex antigens and single nucleotide polymorphisms.

48. The method according to claim 39, wherein the DNA array is formed by arranging a plurality of probes in row and column directions, and
the layout information expresses the positions of the hybridized probes on the DNA array using row and column addresses.

49. The method according to claim 39, wherein the authentication information and registration information contain person specifying information for specifying a given person, and
the authentication step includes the step of making authentication by searching said storage means for registration information which contains the same person specifying information as the person specifying information contained in the authentication information generated in the generation step, and collating the layout information of the generated authentication information and the registration information found by search.

50. The method according to claim 39, wherein an apparatus having the acquisition step and the generation step, and an apparatus having said storage means and the authentication step are connected via the Internet, and the authentication information is sent via the Internet.

51. A method for sending an authentication request to an external apparatus, comprising:
the acquisition step of acquiring layout information that represents a layout pattern of reaction probes obtained by reacting a DNA array on which a plurality of probes are arranged by reading an authentication certificate;
the generation step of generating authentication information on the basis of the layout information acquired in the acquisition step;
the registration request step of sending the authentication information to the external apparatus to request user registration; and
the authentication request step of sending the authentication information to the external apparatus to request authentication.

52. A method for making user authentication in response to an authentication request from an external apparatus, comprising:
the reception step of receiving authentication information which includes layout information that represents a layout pattern of reaction probes obtained by reacting a DNA array on which a plurality of probes are arranged with DNA of a given person, and instruction information indicating a registration request or authentication request;
the registration step of making, when the instruction information indicates the registration request, user registration on the basis of the authentication information received in the reception step; and
the authentication step of making, when the instruction information indicates the authentication request, user authentication on the basis of the authentication information received in the reception step, and registration contents registered in the registration step.

53. An authentication certificate used to authenticate a person, comprising:
a base; and
a holding portion for making said base hold information that represents a layout pattern of reaction probes obtained by reacting a DNA array having a known layout of a plurality of probes with DNA of the person.

54. The certificate according to claim 53, wherein said holding portion holds the information that represents the layout pattern of the reaction probes by attaching the reacted DNA array.

55. The certificate according to claim 53, wherein said holding portion holds the information that represents the layout pattern of the hybridized probes by one of magnetic recording and digital recording.

56. The certificate according to claim 55, wherein the DNA array is formed by arranging a plurality of probes in row and column directions, and
the information that represents the layout pattern of the reaction probes contains position information which expresses positions of the hybridized probes on the DNA array by row and column addresses.

57. A computer readable medium which stores a control program for making a computer execute an authentication process for personal authentication using storage means for storing registration information which includes layout information that represents a layout pattern of hybridized probes obtained by reacting a DNA array on which a plurality of probes are arranged with DNA of a given person, said control program comprising:
a code of the acquisition step of acquiring the layout information from an authentication certificate;
a code of the generation step of generating authentication information on the basis of the layout information acquired in the acquisition step; and
a code of the authentication step of making authentication by collating the authentication information generated in the generation step with the registration information stored in said storage means.

58. A computer readable program which stores a control program for making a computer execute an authentication process for making authentication using an authentication certificate attached with a layout pattern of hybridized probes on a DNA array on which a plurality of probes are arranged, said control program comprising:
a code of the acquisition step of acquiring layout information that represents the layout pattern of the hybridized probes by reading the authentication certificate;
a code of the generation step of generating authentication information on the basis of the layout information acquired in the acquisition step;
a code of the registration request step of sending the authentication information to the external apparatus to request user registration; and
a code of the authentication request step of sending the authentication information to the external apparatus to request authentication.

59. A computer readable medium which stores a control program for making a computer execute an authentication process for making authentication on the basis of layout information that represents a layout pattern of hybridized probes obtained by reacting a DNA array on which a plurality of probes are arranged with DNA of a given person, said control program comprising:
a code of the input step of inputting authentication information containing the layout information, and instruction information indicating a registration request or authentication request;
a code of the registration step of making, when the instruction information indicates the registration request, user registration on the basis of the authentication information received in the reception step; and
a code of the authentication step of making, when the instruction information indicates the authentication request, user authentication on the basis of the authentication information received in the reception step, and registration contents registered in the registration step.
